(19) United States
(12) Patent Application Publication
(10) Pub. No.: US 2015/0357775 A1
(43) Pub. Date: Dec. 10, 2015

(54) TWO IN ONE ELECTRICAL CONNECTOR

(71) Applicant: ALLTOP ELECTRONICS (SUZHOU) LTD., Taicang City (CN)

(72) Inventors: Wang-I YU, JHONGHE City (TW); Hung-Chi TAI, JHONGHE City (TW); Yung-Chih HUNG, JHONGHE City (TW); Ya-Juan GOU, JHONGHE City (TW); Dan LI, JHONGHE City (TW); Qing-Fang DENG, JHONGHE City (TW)

(73) Assignee: ALLTOP ELECTRONICS (SUZHOU) LTD., Taicang City (CN)

(21) Appl. No.: 14/469,060

(22) Filed: Aug. 26, 2014

(30) Foreign Application Priority Data
Jun. 6, 2014 (CN) 201410248849.0
Jun. 6, 2014 (CN) 201410249947.6

(51) Int. Cl. H01R 27/00; H01R 13/502

(52) U.S. Cl. CPC H01R 27/00; H01R 13/502

(57) ABSTRACT

A two in one electrical connector is adapted for selectively mating with a first mating plug and a second mating plug with different widths. The two in one electrical connector includes an insulative housing with a tongue, a number of contacts retained in the insulative housing, an internal shell covering the insulative housing, and an external shell surrounding the inner shell. The internal shell has a receiving space to receive the tongue, an enclosed first mating end, and a first opening close to the first mating end. The opening does not penetrate the first mating end. The external shell has a first resisting arm extending into the receiving space for positioning the first mating plug. The two in one electrical connector can not only retain the first mating plug, but also effectively improve the strength of the mating port thereof.

### BACKGROUND

1. Technical Field

The present disclosure relates to a two in one electrical connector, and more particularly to a two in one electrical connector for mating with two kinds of mating plug with different widths.

2. Description of Related Art

Technologies today have been transformed rapidly. They are utilized approximately in all social sectors and closely connect with people's life. Communication technology applied in those computer-peripheral devices generally uses transmission cables to up/download with mass data. The plug assembled with a cable which is predetermined to be inserted into a socket on a device, thus plays a role as being a key element in communication technology. Recently, the following standards “High Definition Multimedia Interface”, abbreviated as “HDMI” promoted by HDMI Licensing, LLC and “DisplayPort” by VESA, are created to behave in addition with high performance. The width dimensions of these two were usually different resulted in the appearance differences between HDMI and DisplayPort. A kind of two in one electrical connector is designed for integrating the DisplayPort and HDMI connectors together to save the space occupied by two different connectors on a circuit board.

However, because the DisplayPort plug is wider than the HDMI plug, and the mating port of the two in one electrical connector is designed corresponding to the DisplayPort plug, then the HDMI plug cannot be positioned in the mating port stably.

TWM452524U1 discloses a kind of two in one electrical connector, which includes an internal shell and an external shell. The internal shell has an opening extending through the mating end of a top wall thereof. The external shell is formed with a position arm passing through the opening to limit the HDMI plug. However, the design of the opening results in the mating end too weak, and the position arm would be easily deformed under a big lateral force.

It is desirable to provide an improved two in one electrical connector for solving above problems.

### SUMMARY

In one aspect, the present invention includes a two in one electrical connector adapted for selectively mating with a first mating plug and a second mating plug with different widths. The two in one electrical connector comprises an insulative housing, a plurality of contacts retained in the insulative housing, an internal shell covering the insulative housing and an external shell surrounding the internal shell. The insulative housing has a tongue. The contacts are disposed on an upper surface and a lower surface of the tongue. The internal shell defines a receiving space to receive the tongue. Wherein the internal shell has an enclosed first mating end and a first opening close to the first mating end, and the first opening does not penetrate the first mating end. The external shell is formed with a first resisting arm extending into the receiving space through the opening. As the first mating plug is inserted into the receiving space, the first mating plug is positioned by the first resisting arm. As the second mating plug is inserted into the receiving space, the second mating plug fills the receiving space.

In another aspect of the present invention, a two in one electrical connector adapted for selectively mating with a first mating plug and a second mating plug with different widths. The two in one electrical connector comprises an insulative housing, a plurality of contacts retained in the insulative housing, an internal shell covering the insulative housing and an external shell surrounding the internal shell. The insulative housing has a tongue. The contacts are disposed on an upper surface and a lower surface of the tongue. The internal shell defines a receiving space to receive the tongue. The internal shell has a first opening and a projecting wall upwardly extending into the first opening. The external shell has a first resisting arm extending into the receiving space through the first opening. The first resisting arm is arranged at an inner side of the projecting wall. The first mating plug is positioned by the first resisting arm when the first mating plug is inserted into the receiving space. The projecting wall abuts against the first resisting arm to prevent the first resisting arm from being deformed. The second mating plug fills the receiving space as being inserted into the receiving space.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The components in the drawing are not necessarily drawn to scale, the emphasis instead being placed upon clearly illustrating the principles of the described embodiments. In the drawings, reference numerals designate corresponding parts throughout various views, and all the views are schematic.

FIG. 1 is a perspective view of a two in one electrical connector in accordance with an illustrated embodiment of the present disclosure;

FIG. 2 is a partially exploded view of the two in one electrical connector as shown in FIG. 1;

FIG. 3 is a similar to FIG. 1, but viewed from another aspect;

FIG. 4 is partially exploded view of the two in one electrical connector as shown in FIG. 3;

FIG. 5 is a similar to FIG. 1, but viewed from another aspect different from that of the FIG. 3;

FIG. 6 is a perspective view of an internal shell and an external shell as shown in FIG. 1; and

FIG. 7 is a similar to FIG. 6, but viewed from another aspect.

### DETAILED DESCRIPTION OF THE ILLUSTRATED EMBODIMENT

Reference will now be made to the drawing figures to describe the embodiments of the present disclosure in detail. In the following description, the same drawing reference numerals are used for the same elements in different drawings.

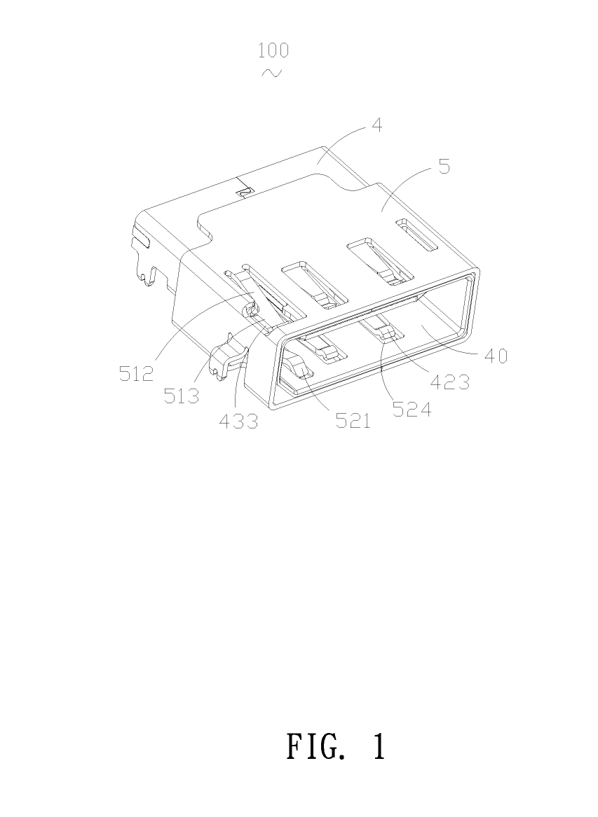

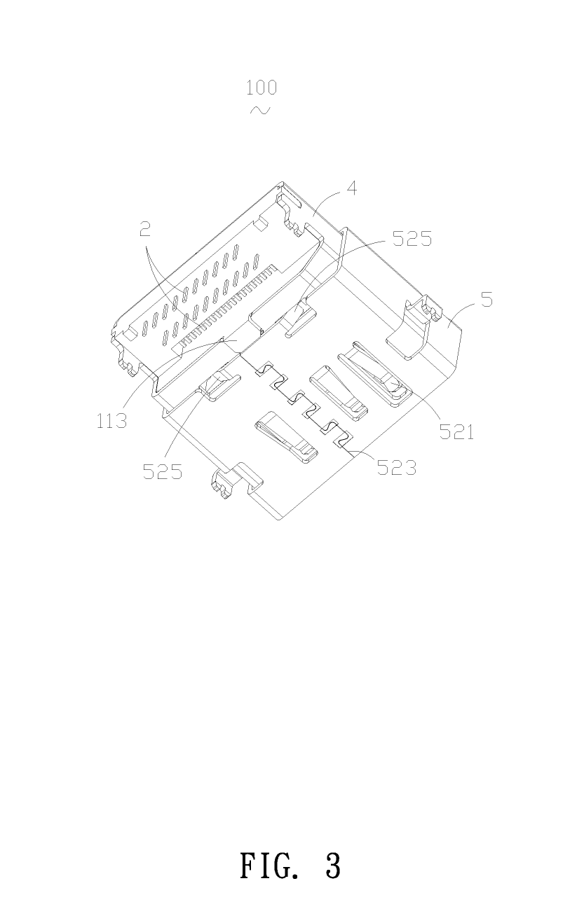

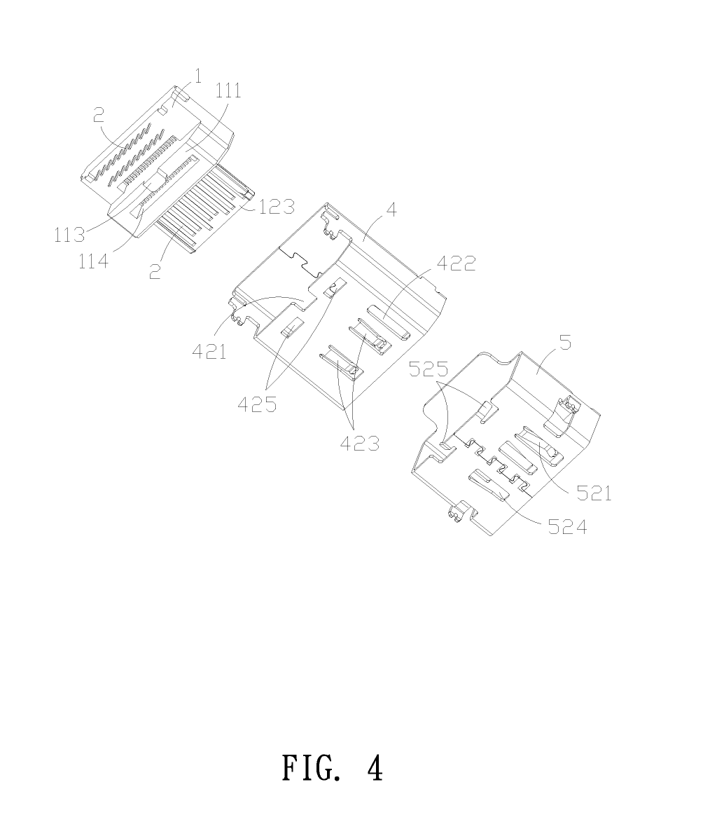

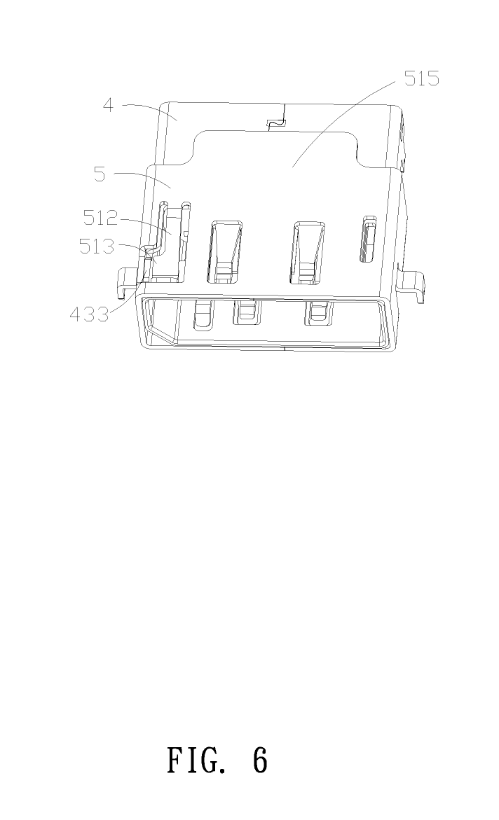

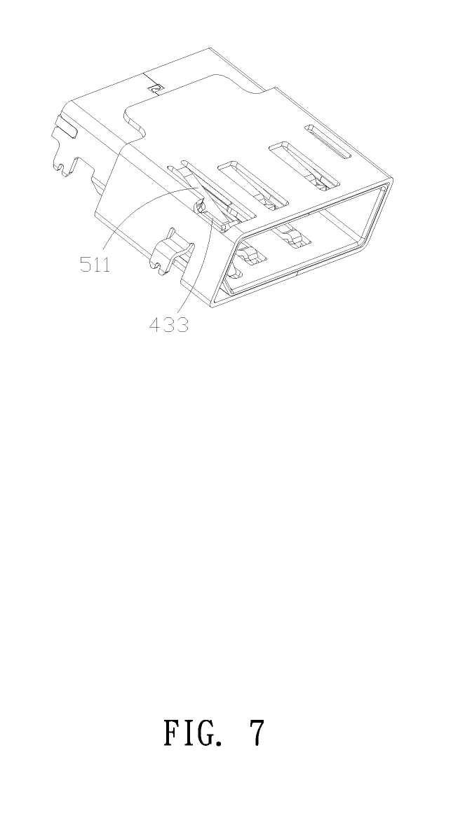

Referring to FIGS. 1 to 7, an illustrated embodiment of the present disclosure discloses a two in one electrical connector 100 adapted for mating with a first plug and a second plug with different widths, such as HDMI plug and DisplayPort plug. Because the HDMI plug and DisplayPort plug are familiar to the technologist in this field, they will not be described below. The two in one electrical connector 100 includes an insulative housing 1, a plurality of contacts 2 fixed in the insulative housing 1, a position pin 3 retained on the insulative housing 1 and extending forwardly, an internal shell 4 covering the insulative housing 1, and an external shell 5 surrounding the internal shell 4.

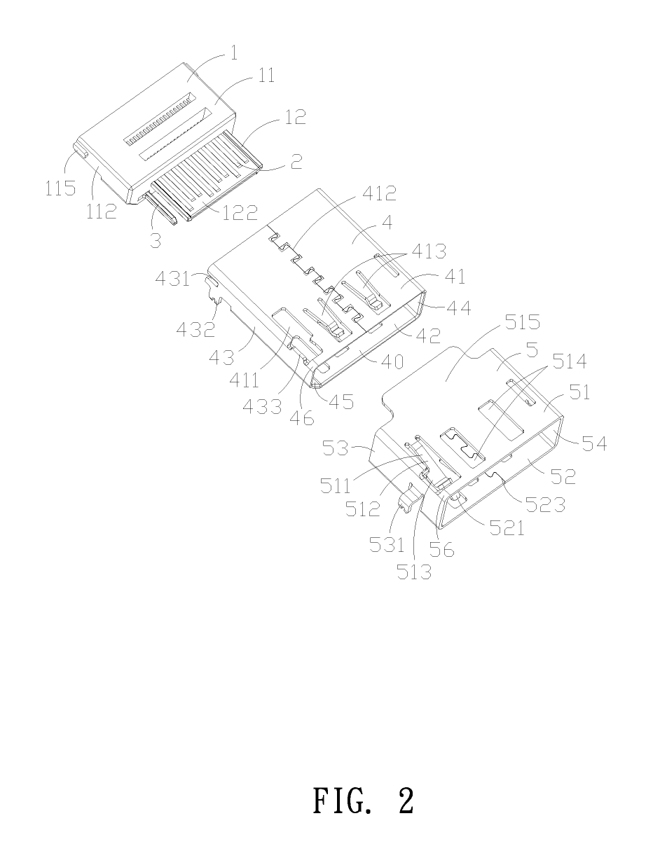

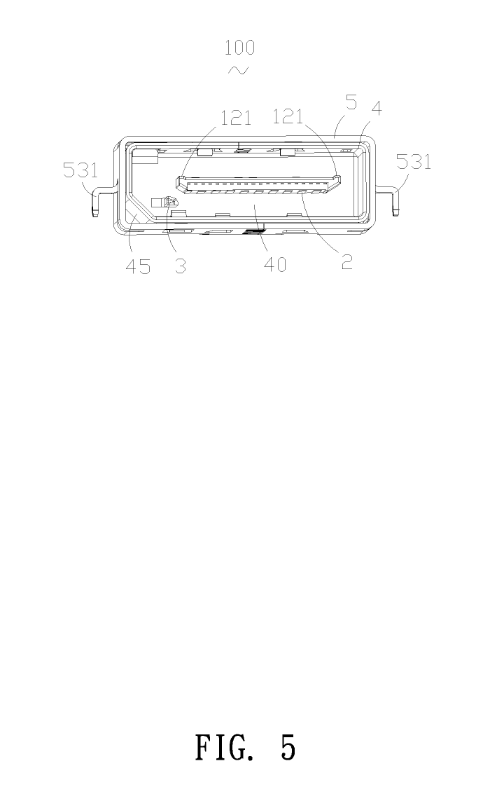

Referring to FIGS. 2 to 5, the insulative housing 1 includes a base 11 and a tongue 12 extending forwardly from the base 11. The base 11 has a bottom wall 111 and two side walls 112. The bottom wall 111 is formed with a rectangular protrusion 113 and a recess 114 at front of the protrusion 113. Each side wall 112 has a projection 115 extending outwardly. Referring to FIG. 5, the tongue 12 has a pair of ribs 121 upwardly extending from two sides thereof. The ribs 121 are used to prevent the HDMI plug from mis-mating. Specifically, when the HDMI plug is inserted reversely, the oblique mating surface thereof will abut against the ribs 121.

The contacts 2 are flatly disposed on upper and lower surfaces of the tongue 12, and exposed outwardly. In the embodiment of the present invention, the contacts 2 are insert-molded in the insulative housing 1 for preventing the contacts 2 from withdrawing from the insulative housing 1.

Referring to FIGS. 1 to 4, the internal shell 4 is made of metallic material, and has a first top wall 41, a first bottom wall 42 opposed to the first top wall 41, a first side wall 43, a second side wall 44 opposed to the first side wall 43 and an oblique wall 45 connecting the first side wall 43 and the first bottom wall 42. The first top wall 41, the first bottom wall 42, the first side wall 43, the oblique wall 45 and the second side wall 44 define a receiving space 40 therebetween. The receiving space 40 is used to receive the HDMI plug or DisplayPort plug. The tongue 12 extends to the receiving space 40. The internal shell 4 is formed with an enclosed first mating end 46 for strengthening the intensity of the mating port thereof. The first top wall 41 is bended by a mental sheet and formed with a first connecting gap 412. Furthermore, the first top wall 41 has a first opening 411 and a pair of first latches 413 extending forwardly and inwardly into the receiving space 40. The first opening 411 is close to the first mating end 46, and does not penetrate the first mating end 46.

The first side wall 43 and the second side wall 44 each has a slot 431 at a rear end thereof and a soldering leg 432 extending downwardly from a lower end thereof. The slots 431 engage with the projections 115 for positioning the internal shell 4 to the insulative housing 1. The soldering legs 432 are used to soldered on a circuit board. The first side wall 43 further has a projecting wall 433 upwardly extending into lateral of the first opening 411. The projecting wall 433 is same as an extension of the first side wall 43.

The bottom wall 42 is formed with a recess 421 at a rear end thereof, a second opening 422 at a front side thereof, a pair of second latches 423 extending into the receiving space 40, and a pair of holes 425 between the second opening 422 and the recess 421. The recess 421 engages with the protrusion 113 to prevent the insulative housing 1 from moving forwardly.

The external shell 5 is made of metallic material, and has a second top wall 51 located above the first top wall 41, a second bottom wall 52 located below the first bottom wall 42, a third side wall 53 at outside of the first side wall 43 and the oblique wall 45, and a fourth side wall 54 at outside of the second wall 44. The external shell 5 is formed with an enclosed second mating end 56 for strengthening the intensity thereof.

Referring to FIGS. 1, 2 and 6, the second top wall 51 is formed with a first resisting arm 511, a pair of first slits 514 at one side of the first resisting arm 511, and an intact drawing surface 515 behind the first slits 514. The first resisting arm 511 presents as a cantilever, and extends into the receiving space 40 through the first opening 411, thereby the first resisting arm 511 is located at inner side of the projecting wall 433. The first resisting arm 511 has a body portion 512 extending along a front to back direction and a widen portion 513 extending laterally from the body portion 512. The projecting wall 433 abuts against the widen portion 513 to prevent the first resisting arm 511 from being deformed laterally. The first slits 514 correspond to the first latches 413 and supply enough deformation space to the first latches 413. The drawing surface 515 is used to be drawn conveniently when the two in one electrical connector 100 is assembled to the circuit board.

The third side wall 53 and the fourth side wall 54 each has a

L-shaped mounting leg 531 for being positioned on the circuit board.

The second bottom wall 52 is formed with a second resisting arm 521 extending into the receiving space 4 through the second opening 422, a pair of second slits 524 corresponding to the second latches 423, and a pair of locking tabs 525 at a rear end thereof. The first resisting arm 511 is wider than the second resisting arm 521, and closer to the third side wall 53 than the second resisting arm 521. The second slits 524 supply enough deformation space to the second latches 423. The second bottom wall 52 is bended by a mental sheet and formed with a second connecting gap 523. The second slits 524 are arranged at two sides of the second connecting gap 523.

Furthermore, the external shell 5 is formed with a number of ribs (not shown) close to the second mating end 56 for strengthening the mating port thereof. Preferably, the ribs are arranged on the inner sides of the second top wall 51, the second bottom wall 52, the third side wall 53 and the fourth side wall 54.

In assembly, the insulative housing 1 is assembled in the internal shell 4, and the external shell 5 surrounds the internal shell 4. The second top wall 51 covers the first top wall 41 with the first connecting gap 412 to strengthen the first top wall 41. The first bottom wall 42 is arranged to correspond to the second bottom wall 52 with the second connecting gap 523 to strengthen the second bottom wall 52. The locking tabs 525 pass through the hole 425 to engage with the recess 114, which make the external shell 5 and the insulative housing 1 be retained together.

As comparatively smaller HDMI plug is inserted into the receiving space 40 correctly, the tongue 12 is received in a mating port of the HDMI plug, and the HDMI plug is limited by one edge of the first resisting arm 511, the position pin 3 and the second resisting arm 521.

Otherwise, once the HDMI plug fails to be inserted correctly, the ribs 121 of the tongue 12 and the position pin 3 will abut against the HDMI plug to prevent the HDMI plug from being inserted into the receiving space 40.

As the DisplayPort plug is inserted correctly, the tongue 12 and the position pin 3 are received in a mating port of the DisplayPort plug, and the DisplayPort plug fills the receiving space 40 and resists the first resisting arm 511 and the second resisting arm 521 outwardly.

Otherwise, once the DisplayPort plug fails to be inserted correctly, the position pin 3 will abut against the DisplayPort plug to prevent the DisplayPort from being inserted into the receiving space 40.

As described above, the two in one electrical connector 100 in the present invention can not only retain the first plug with smaller width, such as the HDMI plug, but also effectively improve the intensify of the mating port thereof.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broadest general meaning of the terms in which the appended claims are expressed.

What is claimed is:

1. A two in one electrical connector adapted for selectively mating with a first mating plug and a second mating plug with different widths, comprising:
an insulative housing having a tongue;
a plurality of contacts retained in the insulative housing and disposed on an upper surface and a lower surface of the tongue;
an internal shell covering the insulative housing and defining a receiving space to receive the tongue;
an external shell surrounding the internal shell;
wherein the internal shell has an enclosed first mating end and a first opening close to the first mating end, and the first opening does not penetrate the first mating end, the external shell being formed with a first resisting arm extending into the receiving space through the opening; as the first mating plug being inserted into the receiving space, the first mating plug being positioned by the first resisting arm; and as the second mating plug being inserted into the receiving space, the second mating plug filling the receiving space.

2. The two in one electrical connector as claimed in claim 1, wherein the external shell is formed with an enclosed second mating end, the first resisting arm presenting as an cantilever and having a body portion extending along a front to back direction and a widen portion outwardly extending from the body portion along a transverse direction.

3. The two in one electrical connector as claimed in claim 1, wherein the internal shell has a first top wall, a first bottom wall, a first side wall, a second side wall and an oblique wall connecting the first side wall and the first bottom wall, the receiving space being formed between the first top wall, a first bottom wall, a first side wall, a second side wall and an oblique wall; the external shell having a second top wall located above the first top wall, a second bottom wall located below the first bottom wall, a third side wall located at outside of the first side wall and the oblique wall, and a fourth side wall located at outside of the second side wall.

4. The two in one electrical connector as claimed in claim 3, wherein the first opening is formed on the first top wall, the first resisting arm being arranged on the second top wall, the first bottom wall defining a second opening, the second bottom wall having a second resisting arm extending into the receiving space through the second opening, the first resisting arm being wider than the second resisting arm, and the first resisting arm being closer to the third side wall than the second resisting arm.

5. The two in one electrical connector as claimed in claim 4, wherein the first top wall and the second bottom wall each is formed with a connecting gap, and the second top wall and the first bottom wall do not have; the first side wall and the second side wall having soldering legs extending downwardly, and the third side wall and the fourth side wall having L-shaped mounting leg extending outwardly.

6. The two in one electrical connector as claimed in claim 1, further comprising a position pin retained on the insulative housing and extending into the receiving space forwardly, the position pin being used to position the first mating plug and prevent the first mating plug from mis-mating.

7. The two in one electrical connector as claimed in claim 1, wherein the tongue is formed with a pair of ribs upwardly extending from two sides thereof to prevent the first mating plug from being inserted reversely.

8. The two in one electrical connector as claimed in claim 1, wherein the contacts are insert-molded in the insulative housing.

9. The two in one electrical connector as claimed in claim 2, wherein the external shell has a number of ribs close to the second mating end.

10. The two in one electrical connector as claimed in claim 1, wherein the first mating plug is HDMI plug, and the second mating plug is DisplayPort plug.

11. A two in one electrical connector adapted for selectively mating with a first mating plug and a second mating plug with different widths, comprising:
an insulative housing having a tongue;
a plurality of contacts retained in the insulative housing and disposed on an upper surface and a lower surface of the tongue;
an internal shell covering the insulative housing and defining a receiving space to receive the tongue;
an external shell surrounding the internal shell;
wherein the internal shell has a first opening and a projecting wall upwardly extending into the first opening, the external shell having a first resisting arm extending into the receiving space through the first opening, and the first resisting arm being arranged at an inner side of the projecting wall; the first mating plug being positioned by the first resisting arm when the first mating plug is inserted into the receiving space, and the projecting wall abutting against the first resisting arm to prevent the first resisting arm from being deformed; the second mating plug filling the receiving space as being inserted into the receiving space.

12. The two in one electrical connector as claimed in claim 11, wherein the internal shell has an enclosed first mating end, and the first opening does not penetrate the first mating end; the external shell having an enclosed second mating end, and the first resisting arm doing not extend through the second mating end.

13. The two in one electrical connector as claimed in claim 12, wherein the internal shell has a first top wall, a first bottom wall, a first side wall, a second side wall and an oblique wall connecting the first side wall and the first bottom wall, the receiving space being formed between the first top wall, a first bottom wall, a first side wall, a second side wall and an oblique wall, the external shell having a second top wall located above the first top wall, a second bottom wall located below the first bottom wall, a third side wall located at outside of the first side wall and the oblique wall, and a fourth side wall located at outside of the second side wall.

14. The two in one electrical connector as claimed in claim 13, wherein the first opening is defined on the first top wall, the first resisting arm being arranged on the second top wall, the projecting wall upwardly extending from the first side wall, the first resisting arm presenting as an cantilever and having a body portion extending along a front to back direction and a widen portion outwardly extending from the body portion along a transverse direction, the projecting wall abutting against the widen portion.

15. The two in one electrical connector as claimed in claim 14, wherein the first bottom wall defines a second opening, the second bottom wall having a second resisting arm extending into the receiving space through the second opening, the first resisting arm being wider than the second resisting arm, and the first resisting arm being closer to the third side wall than the second resisting arm.

16. The two in one electrical connector as claimed in claim 13, wherein the first top wall and the second bottom wall are formed with a connecting gap, and the second top wall and the first bottom wall do not have; the first side wall and the second side wall having soldering legs extending downwardly, and the third side wall and the fourth side wall having L-shaped mounting leg extending outwardly.

17. The two in one electrical connector as claimed in claim 11, further comprising a position pin retained on the insulative housing and extending into the receiving space forwardly, the position pin being used to position the first mating plug and prevent the first mating plug from mis-mating.

18. The two in one electrical connector as claimed in claim 11, wherein the tongue is formed with a pair of ribs upwardly extending from two sides thereof to prevent the first mating plug from being inserted reversely.

19. The two in one electrical connector as claimed in claim 11, wherein the contacts are insert-molded in the insulative housing.

20. The two in one electrical connector as claimed in claim 12, wherein the external shell has a number of ribs close to the second mating end.
